(19) United States
(12) Patent Application Publication
(10) Pub. No.: US 2017/0114820 A1
(43) Pub. Date: Apr. 27, 2017

(54) FASTENING ELEMENT MADE OF PLASTIC WITH SELF-TAPPING AND LOCKING THREAD FOR COMPONENTS

(71) Applicant: GM GLOBAL TECHNOLOGY OPERATIONS LLC, Detroit, MI (US)

(72) Inventors: Manuel FRIEDL, Ruesselsheim (DE); Arne SCHÖNEFELD, Degersheim (CH)

(73) Assignee: GM GLOBAL TECHNOLOGY OPERATIONS LLC, Detroit, MI (US)

(21) Appl. No.: 15/129,274

(22) PCT Filed: Mar. 25, 2015
(86) PCT No.: PCT/EP2015/000635

§ 371 Date: Sep. 26, 2016

(30) Foreign Application Priority Data
Mar. 26, 2014 (DE) 10 2014 004 306.1

(51) Int. Cl. F16B 37/00; B60R 13/08; B62D 35/02; F16B 33/00; B62D 27/02

(52) U.S. Cl. CPC F16B 37/005; F16B 33/006; B62D 27/023; B62D 35/02; B60R 13/0861; B60R 2013/0807

(57) ABSTRACT

A fastening element is disclosed for screwing onto a threaded pin. The fastening element includes a rotation-symmetrical hole of an inner diameter formed by a recess, which is larger than a thread base diameter and smaller than a thread outer diameter of the threaded pin. At least one chip receiving groove in a longitudinal direction of the recess is formed in the recess of the break-through. The fastening element has a lower hardness than the threaded pin.

### CROSS-REFERENCE TO RELATED APPLICATION

This application is a National Stage of International Application No. PCT/EP2015/000635, filed Apr. 2, 2015, which claims priority to German Application No. 102014004306.1, filed Mar. 26, 2014. The disclosures of these applications are hereby incorporated by reference in their entirety.

### TECHNICAL HELD

The invention relates to a fastening element made of plastic with self-tapping thread, to a use of the fastening element for fastening components, and to a vehicle comprising such a fastening element.

### BACKGROUND

Such a generic fastening element is disclosed in the German Utility Patent DE 203 07 622 U1, which relates to a screw connection for fastening an attachment part to a plastic wall with a plastic screw. The plastic screw consists of a plastic that is harder than the plastic of the plastic wall and is provided with a self-tapping thread which taps into the plastic wall so that a self-locking screw connection is created. When such self-tapping screws cut into a material, chip material can be accrued which is embedded between the thread and the material and leads to an increase of the torque required for turning the screw.

### SUMMARY

The object of the invention consists in providing a self-tapping fastening means with which changes of the torque required for screwing onto a thread because of accrued chip material are reduced or minimized.

The invention is obtained from the characterizing features of the independent claims. Advantageous further developments and configurations are subject of the dependent claims. Further characterizing features, application possibilities and advantages of the invention are obtained from the following description and the explanation of exemplary embodiments of the invention which are shown in the figures.

In a first aspect, the object is solved through a fastening element for screwing onto a threaded pin, comprising a rotation-symmetrical hole of an inner diameter formed by a recess, which is greater than the thread base diameter and smaller than the thread outer diameter of the threaded pin, wherein at least one chip receiving groove extending in longitudinal direction of the hole is formed in the wall of the recess that forms the hole. It is provided that the fastening element in each case has a lower hardness than the threaded pin, onto which it is screwed.

Through the dimensions of the rotation-symmetrical hole, the diameter of which allows a passage of the threaded pin with its thread base diameter, but which is smaller than the thread outer diameter of the threaded pin, it is ensured that the thread of the threaded pin taps into the wall of the recess when the hole of the fastening element is placed onto the threaded pin and under pressure is rotated in thread direction. Between the tapping threaded pin and the wall of the recess a self-locking screw connection is thus created. The wall of the recess now comprises at least one chip receiving groove extending in longitudinal direction of the recess, wherein longitudinal direction covers any direction which does not perpendicularly stand on the axis of the recess. Chip material, which during the tapping of the thread into the wall of the recess is severed from the same, is transported during the turning of the thread relative to the wall until it reaches a chip receiving groove. In this chip receiving groove the chip material is deposited as a result of which during the turning of the thread it does not cause any additional friction forces. Chip material here is to mean any material of the wall which during the course of the screwing-on onto the thread of the threaded pin is liberated by the wall, i.e. not only macroscopic chips but in particular also microscopically or sub-microscopically small particles. Because of the fact that the chip material can become deposited in the at least one chip receiving groove and additional friction forces are minimized, a torque that substantially remains the same is advantageously made possible or taking into account the fact that with increasing tapping of the thread into the wall of the recess the contact surface and thus friction surface between the fastening element and the threaded pin is increasingly enlarged, a substantially evenly increasing torque. During assembly operations, standardized torques or torque curves can thus be used as a base, wherein it is ensured that reaching a given maximum torque is not erroneously caused by chip material.

According to a further development, the total volume that is provided by the at least one chip receiving groove is dimensioned so that it corresponds at least to the volume of the accrued chip material Which for example can be approximately determined as the volume of the proportion of the thread which is to lockingly engage in the wall of the recess. The at least one chip receiving groove can have any shape, for example, around, in particular a substantially half-round cross section, or an angular, for example triangular, quadrangular or polygonal cross section.

The fastening element can take any shape which can be easily chosen by the person skilled in the art knowing the inventive idea and the invented use. Non-limiting examples for corresponding further developments are washer forms, such as for example round or oval washer forms, or polygonal washer forms such as for example triangular, quadrangular or hexagonal washer forms. For saving weight, for the sake of the fit or for design reasons, the washers, in addition to the recess, which provides the rotation-symmetrical hole required for receiving the threaded pin, can comprise one or more further recesses.

According to an embodiment, the hole of the fastening element is a blind hole. This embodiment is suitable for providing a fastening means with a substantially smooth surface, by way of which advantageously low aerodynamic resistances are achievable and furthermore entering of liquid or dirt particles from the surface of the fastening means opposite to the blind hole in the direction of the blind hole and thus in the direction of the threaded pin is prevented.

According to a further embodiment, the hole of the fastening means is a through-hole so that the recess constitutes a break-through, as a result of which applications are advantageously made possible in the case of which a passage of the threaded pin through the fastening means is provided.

According to a further embodiment, a plurality of chip receiving grooves are provided in the wall of the recess, for example two to eight chip receiving grooves, preferentially two to six chip receiving grooves and in particular two to four chip receiving grooves. The chip receiving grooves are preferentially evenly distributed, i.e. arranged parallel to one another along the wall. The total volume that is provided by the chip receiving groove or chip receiving grooves is preferentially dimensioned so that it corresponds to the total volume of expected accrued chip material or slightly exceeds the same for example by 5 to 50 per cent such as for example 10 to 30 per cent. By providing a plurality of chip receiving grooves the volume of each individual chip receiving groove can be kept low, as the result of which a structural weakening of the wall of the fastening element is advantageously prevented. Furthermore, the distance that the severed chip material has to cover up to the next chip receiving groove so that fluctuations of the torque to be applied in view of the instantaneous friction forces caused through the severed chip material while rotating the fastening element on the threaded pin and pending the reaching of the next chip receiving groove are advantageously reduced. The chip receiving grooves can have a round or angular cross section.

According to an embodiment, an extent of the at least one chip receiving groove is present in longitudinal direction of the recess and the hole formed by the same so that the same extends in axial direction of the hole. If a plurality of chip receiving grooves is present, or, according to a further development, are preferentially present in axial direction.

According to a further embodiment, the at least one chip receiving groove extends at an angle to the axial direction of the hole. Accordingly, the same when viewed three-dimensionally forms a helix or part-helix along the surface of the recess. In the presence of a plurality of chip receiving grooves, these preferentially assume the same angle to the axial direction. The reduction of the wall thickness which is caused by the chip receiving groove or chip receiving grooves does not therefore concentrate in axial direction on one or a plurality of places which correspond to the number of chip receiving grooves but is advantageously evenly distributed radially about the axis.

According to an embodiment, the rotation-symmetrical hole is formed cylindrically, i.e. has the same diameter at any point. Such fastening means are advantageously suitable for screwing onto threaded pins which are likewise formed cylindrically.

According to a further embodiment, the hole is embodied tapered, which also includes truncated cone forms, for example when embodied as fastening means with blind hole. The taper angle in particular further developments of the embodiment amounts to 0.1° to 15°, for example 0.5° to 12.5°, in particular 1′ to 10°. Such fastening means are for example advantageously suited for screwing onto tapered threaded pins included truncated cone-shaped threaded pins. Furthermore, such fastening means however are also advantageously suited for screwing onto cylindrical threaded pins. In this case, the inner diameter of the rotation-symmetrical hole, which is greater than the thread base diameter and smaller than the thread outer diameter of the threaded pin, relates to the inner diameter measured at the point of the tapered and in particular truncated cone-shaped hole with the smallest diameter. When a threaded pin is screwed onto a fastening element, which comprises a hole with a taper angle, a larger contact surface between the wall of the recess forming the hole and the thread of the threaded pin and thus an improved hold in the screwed state is advantageously provided. According to a particular further development, the tapered whole is formed truncated cone-shaped, its inner diameter on the cover surface of the truncated cone, i.e. the surface with the least diameter of the truncated cone, is greater than the thread base diameter of the thread pin to be screwed on, and wherein its inner diameter on the base surface of the truncated cone, i.e. the surface with the largest diameter of the truncated cone, is smaller than the thread outer diameter of the threaded pin.

According to a further embodiment mixed forms of cylindrical and tapered holes are provided, for example for receiving threaded pins with cylindrical basic form, which are tapered at an end.

According to an embodiment, the fastening means comprises a handling projection which advantageously facilitates gripping the fastening means by a user and/or screwing onto a threaded pin. According to a further development, the handling projection is formed quadrangular or hexagonal-like. This projection formed quadrangular or hexagonal-like is for example matched to a handling tool with a likewise quadrangular or hexagonal-like nut for engaging in the projection so that by means of the handling tool the fastening means can be screwed onto the threaded pin. According to a further development, the fastening element is designed washer-like, wherein the hole is arranged in the middle the handling projection is molded onto one side. Preferentially, the projection has a smaller diameter than the fastening element formed disc-like onto which it is molded.

According to an embodiment, the fastening element comprises one or a plurality of plastics, metals or metal alloys or combinations thereof or consists of one or a plurality of the aforementioned representatives. According to a particular embodiment, the fastening element consists of a plastic. Suitable materials and plastics are easily determinable by the person skilled in the art knowing the inventive idea, wherein non-restrictive examples for plastic comprises polyamide, polyacrylic, polycarbonate, polyetheretherketone, polyethylene, polypropylene, polystyrene, polyvinylIdene fluoride and polyurethane, which if appropriate can contain carbon fibers or glass fibers as reinforcing elements. Particular examples for plastics for producing fastening elements are polyamides, in particular PA 6, PA 6.6, PA 6.10, PA 6.12, PA 11 and PA 12. In particular further developments, the plastic is polyamide, polyetheretherketone or polyvinylIdene fluoride. Advantageously, by using fastening elements made from plastic, the problem of contact corrosion is avoided even if the fastening element is screwed to a threaded pin made of metal. Surprisingly, using polyamides, at least of the type PA 6 and PA 6.6 a usability when over-turning the formed screw connection was also advantageously established, wherein it was possible to again separate the fastening element and the threaded pin by turning in the direction opposite to that during screwing on and again durably screw the same together.

In a further aspect, the object is solved by using a fastening element as described above for fixing components to a vehicle, in particular a motor vehicle, such as for example cover panels such as for improving the aerodynamics, for heat insulation or for splash water protection. According to a particular embodiment, the component is a heat shield of a vehicle, in particular of the motor vehicle, which is fastened to the vehicle, for example to the vehicle underbody.

Preferentially, fastening elements of plastic were used for this purpose which correspond to the relevant requirements in terms of load bearing capacity, temperature resistance and if applicable further parameters such as chemical compatability. For uses, in which heat shields are fastened to vehicles no that there are elevated requirements in terms of temperature resistance, examples for preferred plastics are polyamides, in particular PA 6, PA 6.6, PA 6.10 and PA 6.12, in particular PA 6.6 and PA 6.10, as well as polyetheretherketone or polyvinylIdene fluoride. Advantageously, cost-effective fastening elements can thereby be provided for example by way of methods that are customary according to the state of the art such as injection molding, which can be flexibly combined with various threaded pins provided the inner diameter of their holes is greater than the thread base diameter and smaller than the thread outer diameter of the threaded pin.

The object of the invention is solved, furthermore, by a vehicle, in particular a motor vehicle, which comprises a fastening element according to the above description.

### BRIEF DESCRIPTION OF THE DRAWINGS

Further advantages, Characterizing features and details are obtained from the following description in which—if applicable making reference to the drawing at least one exemplary embodiment is described in detail. Same, similar and/or functionally same components are marked with the same reference characters.

It shows:

FIGS. 1A and 1B show a fastening element in top view and three-dimensional view;

FIGS. 2A-2C show sectional views of fastening elements in three-dimensional view; and

FIG. 3 shows a three-dimensional view of a fastening element with a heat shield.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

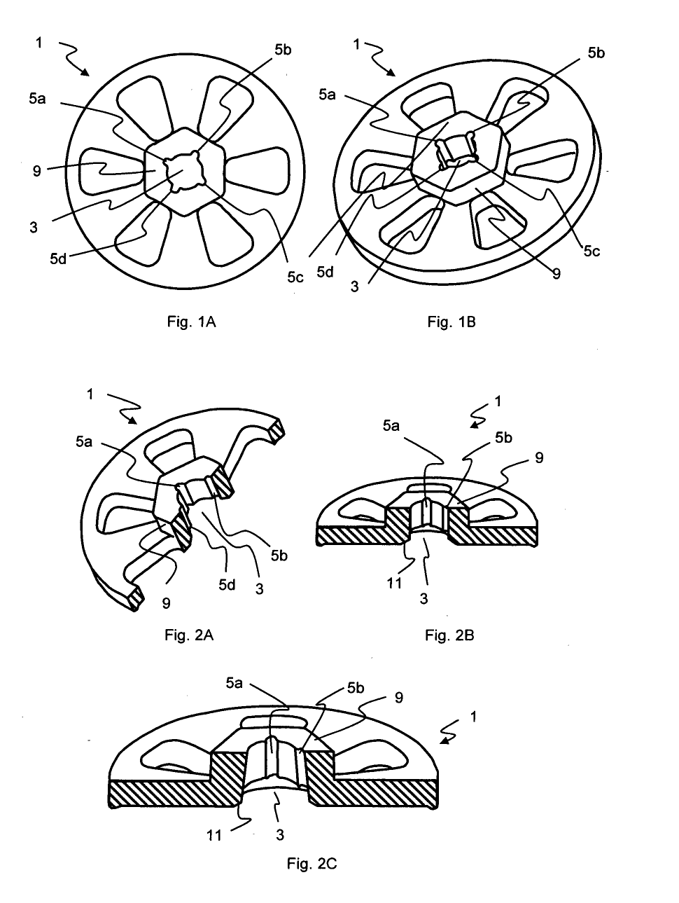

FIG. 1A shows a top view and FIG. 1B shows a three-dimensional view of a fastening element 1 with a rotation-symmetrical hole 3. The rotation-symmetrical hole 3 comprises four chip receiving grooves 5a, 5b, 5c, 5d which receive chip material, which is created when a threaded pin 7 which is not shown is screwed into the hole 3. The fastening element 1 as a whole is formed washer-like and furthermore comprises a handling projection 9, which is formed hexagonally, wherein the rotation-symmetrical hole 3 extends through the washer-like fastening element 1 with the handling projection 9 molded thereon. The handling projection 9 makes possible, for example, starting a wrench as handling instrument in order to screw the fastening element 1 onto a threaded pin 7. From FIG. 1A it is evident that in the shown example the rotation-symmetrical hole 3 is formed cylindrically and the chip receiving grooves 5a, 5b, 5c, 5d have a substantially half-round cross section. FIG. 13 shows that the chip receiving grooves 5a, 5b, 5c, 5d extend in axial direction of the hole 3.

The fastening element 1 preferentially consists of a plastic and can be produced in one piece for example by injection molding. Depending on the application, the plastic is suitably selectable by the person skilled in the art so that it has the required hardness and temperature resistance.

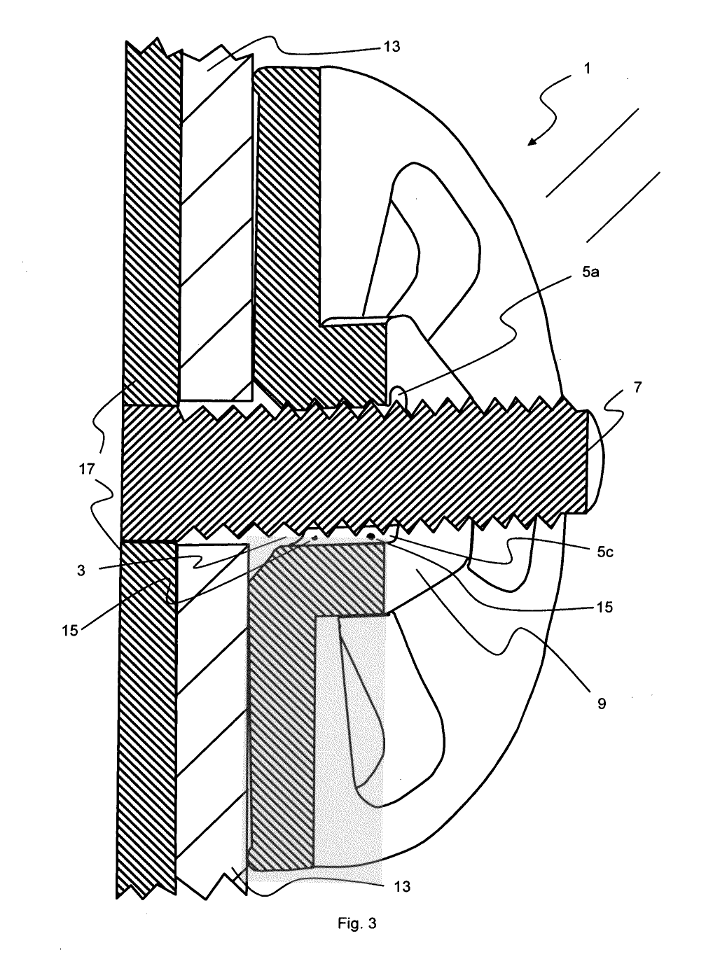

FIGS. 2A and 2B show three-dimensional sectional representations of a fastening element 1 in different perspectives. The section plane substantially extends in the middle through the rotation-symmetrical hole 3 so that altogether three chip receiving grooves 5a, 5b, 5d are shown, wherein the chip receiving groove 5a is shown completely and the two other chip receiving grooves 5b and 5d are partially shown. FIG. 23 shows a further sectional representation with slightly varied section plane, which no longer covers the chip receiving groove 5d shown in FIG. 2A. As further configuration, an inlet region 11 into the hole 3 that is advantageously configured chemically is noticeable, which facilitates placement onto a threaded pin 7. FIG. 2C shows an example for a particular further development of the fastening element 1, in which the hole 3 is not formed cylindrically but in the form of a truncated cone, so that the wall of the recess forming the hole 3 has a taper angle with respect to the taper axis of the hole 3. As also in part FIG. 2B, the shown further development additionally shows an inlet region 11 formed tapered, which has a significantly increased taper angle for facilitating placement onto a threaded pin 7 which is not shown.

FIG. 3 shows a fastening element 1 in three-dimensional sectional representation, wherein a threaded pin 7 is now passed through the hole 3. The thread of the threaded pin 7, on the side shown at the top in FIG. 3, taps into the wall of the break-through, which forms the hole 3 of the fastening element 1. Behind the section plane is located the chip receiving groove 5a. In the present section plane, the chip receiving groove 5c for depositing chip material 15, which can be accrued when tapping the threaded pin 7 into the wall of the break-through which forms the hole 3, is located on the opposite side of the threaded pin 7 shown in FIG. 3 at the bottom. Since the chip material 15 after a short distance in which it is transported between the fastening means 1 when turning the same and the threaded pin 7, is deposited in a chip receiving groove 5, it does not permanently result in elevated friction which when screwing the fastening element 1 onto the threaded pin 7 would require a substantially rising torque. Representative of a component which can be fastened by way of the fastening element 1, a heat shield 13 is shown in FIG. 3, which is fixed to a vehicle underbody 17, which in turn is representative of any part of a vehicle, in particular a motor vehicle, on which components can be fastened.

Although the invention was illustrated and explained in more detail by way of preferred exemplary embodiments the invention is not restricted to the disclosed examples and other variations can be derived from this by the person skilled in the art without leaving the scope of protection of the invention. It is therefore clear that a plurality of variation possibilities exists. It is likewise clear that exemplarily mentioned embodiments really represent only examples which must not be interpreted in any way as limitation for example of the scope of protection, the application possibilities or the configuration of the invention. The preceding description and the figure description rather enable the person skilled in the art to specifically implement the exemplary embodiments, wherein the person skilled in the art knowing the disclosed inventive idea can carry out a wide range of changes for example with respect to the function or the arrangement of individual elements mentioned in an exemplary embodiment without leaving the scope of protection as defined by the claims and their legal equivalents for example further explanation in the description.

1-15. (canceled)

16. A fastening element configured to screw onto a threaded pin, the fastening element comprising a rotation-symmetrical hole formed by a recess of an inner diameter that is greater than a thread base diameter and smaller than a thread outer diameter of the threaded pin, wherein at least one chip receiving groove extending in longitudinal direction of the recess is formed in the recess and the fastening element has a lower hardness than the threaded pin.

17. The fastening element according to claim 16, wherein the hole comprises a blind hole.

18. The fastening element according to claim 16, wherein the hole comprises a through-hole.

19. The fastening element according to claim 16 further comprising a plurality of chip receiving grooves evenly distributed about a circumference of the hole.

20. The fastening element according to claim 16, wherein the at least one chip receiving groove extends in an axial direction of the hole.

21. The fastening element according to claim 16, wherein the at least one chip receiving groove extends at an angle to an axial direction of the hole.

22. The fastening element according to claim 16, wherein the hole comprises a cylindrical bore.

23. The fastening element according to claim 16, wherein the hole comprises a tapered bore.

24. The fastening element according to claim 16, wherein the fastening element comprises a handling projection.

25. The fastening element according to claim 24, wherein the ha projection is formed quadrangular-like.

26. The fastening element according to claim 24, wherein the handling projection is formed hexagonal-like.

27. The fastening element according to claim 24, wherein the fastening element comprises a washer, wherein the hole is arranged in the middle and molded onto a side of the handling projection.

28. The fastening element according to wherein the fastening element comprises a plastic element.

29. The fastening element according to claim 28, wherein the plastic element is selected from the group consisting of polyamide, polyetheretherketone or polyvinylIdene fluoride.

30. An apparatus comprising the fastening element according to claim 16 fixing a heat shield of a motor vehicle to a vehicle underbody.

31. A motor vehicle comprising a vehicle underbody and the fastening element according to claim 16 affixing a heat shield to the vehicle underbody.
